(19) United States
(12) Patent Application Publication
(10) Pub. No.: US 2006/0112104 A1
(43) Pub. Date: May 25, 2006

(54) Apparatus and method of hosting on-demand business context information

(76) Inventors: Lianjun An, Yorktown Heights, NY (US); Shubir Kapoor, Shrub Oak, NY (US)

Correspondence Address: Whitham, Curtis, & Christofferson, P.C.;Suite 340, 11491 Sunset Hills Road, Reston, VA, 20190, US

(21) Appl. No.: 10/994,230

(22) Filed: Nov. 23, 2004

(51) Int. Cl. G06F 17/30

(52) U.S. Cl. 707/10

(57) ABSTRACT

A framework is provided to serve on-demand business data and set up a business context hosting layer between the business logic and a display layer. An object extendable model is used to represent a KPI and to handle domain specific artifacts. The domain independent core component processes domain specific business data through meta data specification in its configuration. It provides a query mechanism that is suitable to retrieve KPIs with multi-dimension value. It allows other components to access the data in real time through multiple interfaces and provides notification capability whenever a KPI value changes.

### BACKGROUND OF THE INVENTION

1. Field of the Invention

The present invention generally relates to Business Performance Management (BPM) applications and, more particularly, to such applications which build on On-Line Analytical Processing (OLAP) technology and receive events in near real time from target business systems, correlate those events, create metrics—Key Performance Indicators (KPIs)—and detect the situations or exceptions based on business solutions.

2. Background Description

Business users need real time notification of occurring situations in their business processes. This requirement can be realized through monitoring Key Performance Indicators (KPIs). In general, a KPI could have multiple dimensions and certain dimensions could consists of sub-dimensions. Also, a KPI could be grouped by several sub-KPIs. For instance, a KPI for on-time-delivery in transportation systems might have the following dimensions: carrier, source location, destination location, and time bucket (daily, weekly, monthly and yearly). KPIs are domain dependent and would be specific to the domain in which they are implemented. It is a usual pattern to have multiple components connected to a central data repository to share transactional information and resources. A database can provide persistent storage for the business transactional data in a normalized structure. But such a data structure may not be suitable for being used to host multi-dimensional KPIs, which are constantly being accessed and updating by different components in near real time.

The basic requirement for a business context in this circumstance is that it should be active, dynamic, support the storage of multi-dimensional data and their relationships, and provide real time capabilities for managing the data which includes query, notification, updating and the like.

Today, people use the operation data store to host the business context and delegate the requirement to database design and setup. Note that the database can provide persistent storage for the business transactional data in a normalized structure; however, it may not be suitable for the interactive systems that hold non-normalized data type with multiple dimensions. In order to advance over the prior art it is essential to have a context object model for the business context and a framework setup on the top of the object model to support these requirements. The business context could be persisted in a data store through mappings between the context object model and a normalized data model, so that the system could be recovered from failure and data could be traced for further analysis.

On-Line Analytical Processing (OLAP) designates a category of applications and technologies that allow the collection, storage, manipulation and reproduction of multidimensional data, with the goal of analysis. OLAP provides a static multidimensional model of structural data with drill-down view capability; however, it is not dynamically context-aware and is built upon the data warehouse.

### SUMMARY OF THE INVENTION

It is therefore an object of the present invention to provide an environment for real time hosting of key performance indicators and to provide services enabling systems accessing these indicators to adapt themselves to changes in the business environment.

According to the invention, a framework is provided to serve on-demand business data and set up a business context hosting layer between the business logic and a display layer. An object extendable model is used to represent a KPI and to handle domain specific artifacts. The domain independent core component processes domain specific business data through meta data specification in its configuration. It provides a query mechanism that is suitable to retrieve KPIs with multi-dimension value. It allows other components to access the data in real time through multiple interfaces and provides notification capability whenever a KPI value changes.

A method according to the invention provides a core set of models for generic key performance indicators used by system components. These models are context object models and configuration models. The context object models provide base representations of the generic key performance indicators, with their data types and dimensions, and also allows extensions of the base representations for specific domains. The method uses the configuration models to customize the context object models for a specific domain occupied by a set of systems and components. The domain has key performance indicators (KPIs). This customization creates a business context hosting layer for access to the KPIs of the domain. The method also provides a set of services for the business context hosting layer. These services allow for querying the KPIs across multiple dimensions and updating said KPIs based on transactional events. The key performance indicators are provided with persistent storage, and are updated and queried in real time.

The business context framework provided by the present invention leverages OLAP technology, especially in the case where it is desired to get some KPIs that are aggregated across a longer time-horizon for the same type and a large space-horizon for a variety of types. In this framework, KPIs, their respective dimensions and appropriate extensions to data types are wired together in an object model.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a functional block diagram illustrating the principal components of the present invention;

FIG. 2 is a block diagram showing the core model and a set of services which comprise the business context;

FIG. 3 is a block diagram showing the architecture and usage of the framework according to the invention;

FIG. 4 is a detailed object model diagram showing some basic measure types and a specialized measure type; and

FIG. 5 is a diagram showing the structure of the business context configuration model.

FIG. 6 is a block diagram illustrating an example of the business context based on a demand supply conditioning scenario.

### DETAILED DESCRIPTION OF A PREFERRED EMBODIMENT OF THE INVENTION

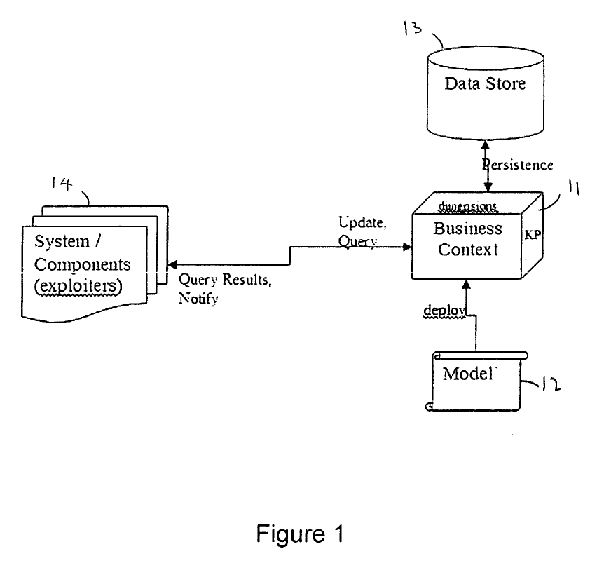

Referring now to the drawings, and more particularly to FIG. 1, there is shown a functional block diagram of the framework according to the invention. The business context 11 is a run time component which is described in terms of a build time model 12 and communicates with a data store 13 which provides persistence to the multi-dimensional data stored therein. The business context 11 is a collection of run time components which construct objects in memory based the model 12. It provides key services to allow for querying KPIs across multiple dimensions as well as updating of the KPIs based on transactional events. The model 12 is based on a core set of context object models and configuration models. The context object models provide the base representation of KPIs, their data types and dimensions. It also has the necessary plug points to enable extensions if needed for specific domains. For example, in a supply chain scenario, forecasts and commits are represented as an array of numbers, each number belonging to a specific future week. To allow for this specialized data type, specific extensions were needed for the context object model. The model 12 also comprises a configuration model which provides the capabilities of customizing the model for a specific domain, e.g. providing the necessary KPIs names, data types (e.g. integer, Boolean) and dimensions (e.g. location, time). The business context 11 exposes key services which are invoked by system components 14. In addition, the business context 11 receives updates from and provides notifications to the system components 14 based on changes made to the hosted KPIs.

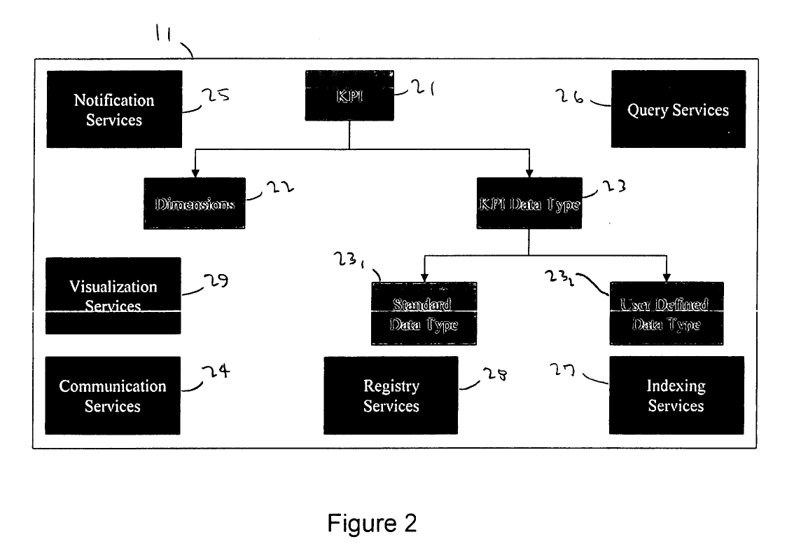

The business context 11 and model 12 is shown in more detail in FIG. 2 and consists of a core model and a set of services. The model comprises the following functional components:
KPIs 21 which are hosted in the context. A KPI (Key Performance Indicator) is a measurement that allows an organization to determine how well it is accomplishing its stated goal. Every KPI has a value which collectively determines the performance of the organization.
Dimensions 22. Each KPI is associated with one or more dimensions. The KPI has a value across all groups of dimensions with which it is associated. The context provides an environment to store the values of the KPIs across multiple dimensions.
Data Type 23. Every KPI value is associated with a data type. The data type could be a standard data type 23₁ (integer, double, etc.) or a user defined data type 23₂.
   The context model is supported by a set of services. The framework consists of the following services:
Communication Services 24 which provides the capabilities for external systems and components to communicate synchronously or asynchronously with the business context.
Notification Services 25 which contains interfaces to provide the capabilities for monitoring the key performance indicators and generating notifications or alerts when out of tolerance situations occur. These notifications are sent out to the right component via the communication services 24.
Query Services 26 which provide capabilities to allow external systems to query the context and retrieve the values of the KPIs across the appropriate dimensions. The query services 26 allows for wildcard as well as fuzzy search capabilities.
Indexing Services 27 which provide capabilities for indexing the information held within the context to speed up the search via the Query Services 26.
Registry Services 28 which provide the “hot deployment” capabilities to register new KPIs and user defined data types on demand.
Visualization Services 29 which provide the ability to view the data hosted within the Business Context 11 on a portal. The Visualization Services 29 provides the capabilities to perform authentication, authorization, personalization and customization to users and role players accessing the portal.

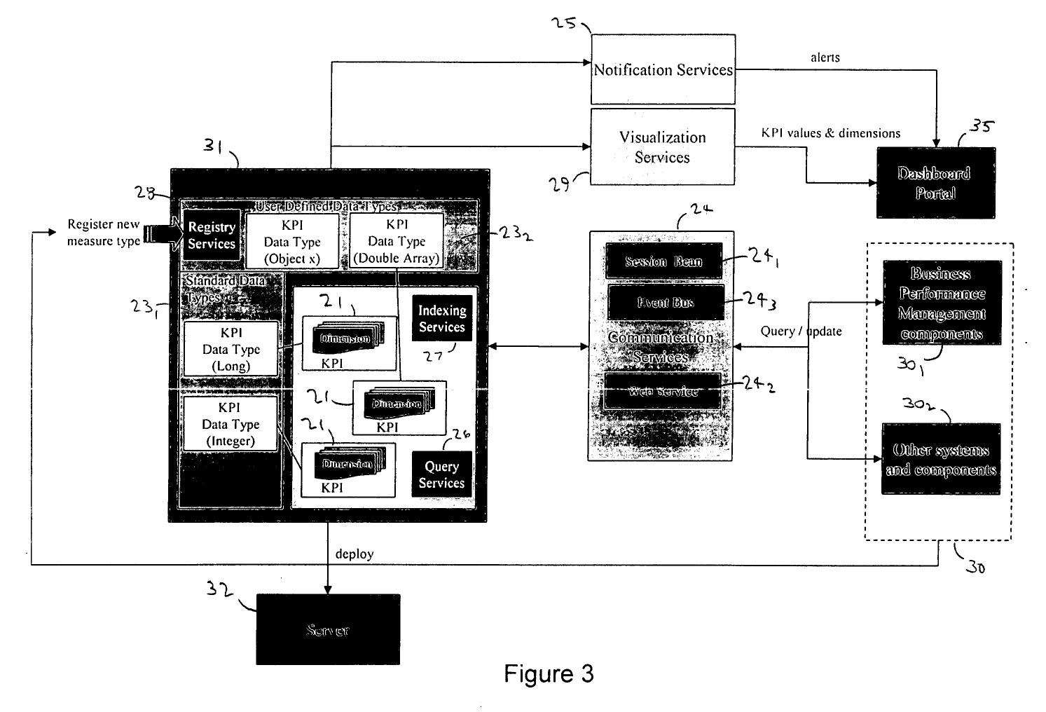

FIG. 3 illustrates the architecture and usage of the framework according to the invention. The core business context 31 is a domain independent runtime component with a generic interface. It consists of a set of KPIs 21 across their corresponding dimensions. The following interactions are possible:
A context 31 is modeled using the model 12.
Standard data types 23₁ are provided by the environment and user defined data types 23₂ can be plugged in and connected to the KPIs 21 if needed using Data Type specification 23.
The context 31 is deployed on a server 32.
The context 31 registers its co-ordinates in a registry using the Registry Services 28. New KPIs and data types can be dynamically registered in the system by connecting to the registry and utilizing the services exposed by the Registry Services 28.
Using the communication services 24, the business context 11 can be exposed to the environment in multiple ways. One implementation could be over an event bus 24₃ to serve local business performance management components 30₁. Another possible implementation could be via a session bean 24₁ or using Webservices 24₂, which could also serve other systems and components 30₂.
External systems and/or components 30 can utilize the context in different ways. Some components 30 update the context 31 as a means to share information with other components whereas other components 30 query the context 31 to retrieve information for analysis purposes.
Some components 30 could be listening for changes or alerts within the context which would broadcast the changes to multiple users via a portal 35. This is achieved using the Notification Services 25.
In order to visualize the contents of the context, the model can be transformed into appropriate views which can be realized on the various forms (browser, standalone client, etc). This is achieved using the Visualization Services 29.

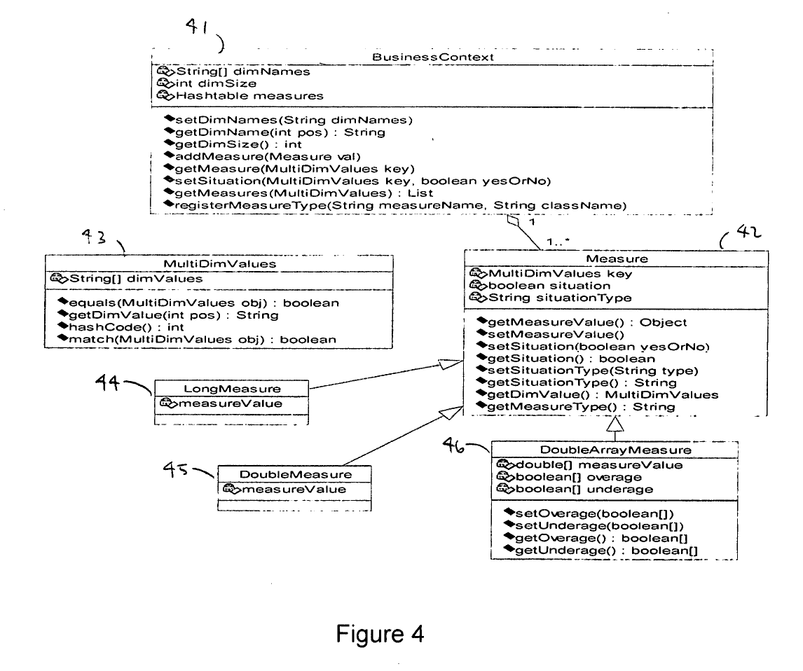

The business context object model is described in FIG. 4 and consists of a root Business Context object 41 which contains a collection of key performance indicators and dimensions. The Business Context object 41 provides the necessary operations to maintain the lifecycle of KPIs and dimensions. KPIs are modeled using the measure object 42 which is uniquely identified by the dimensions it is modeled across using the MultiDim Values object 43. The MultiDim Values object 43 maintains a list of dimensions and provides the necessary operations to allow for fuzzy and wildcard searching. Wildcard searching is done by substituting dimensions values with characters like “*” and “?”. Measure 42 is an abstract object and is extended with the appropriate data type in order to realize it. Each KPI defined within the model needs to be associated with a specific data type. The model provides certain standard data types (integer, long, double) and is extensible and allows for the creation of new data types if necessary. FIG. 4 demonstrates some basic measure types (LongMeasure 44, DoubleMeasure 45) and a specialized measure type—DoubleArrayMeasure 46 which is suitable to represent a multi valued KPI with specific attributes called overage and underage which is exploited by the notification services 25 appropriately.

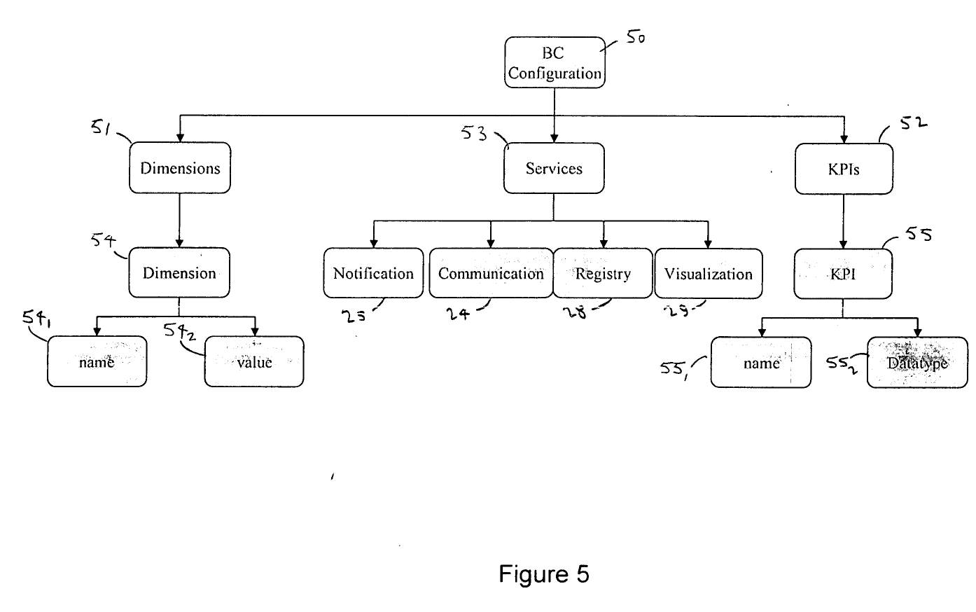

The business context configuration model 50 is described in FIG. 5. It consists of the following specification
Dimensions 51—which allows the user to customize and specify dimensions according to the domain in which the business context is being utilized, providing a name 54₁ and corresponding value 54₂ for each dimension 54.
KPIs 52—which allows the user to specify the KPI 55 names 55₁ and corresponding data type 55₂ which is an extension of the Measure Object 42 as modeled in the object model.
Services 53—configurations for the various services provided by the Business Context.

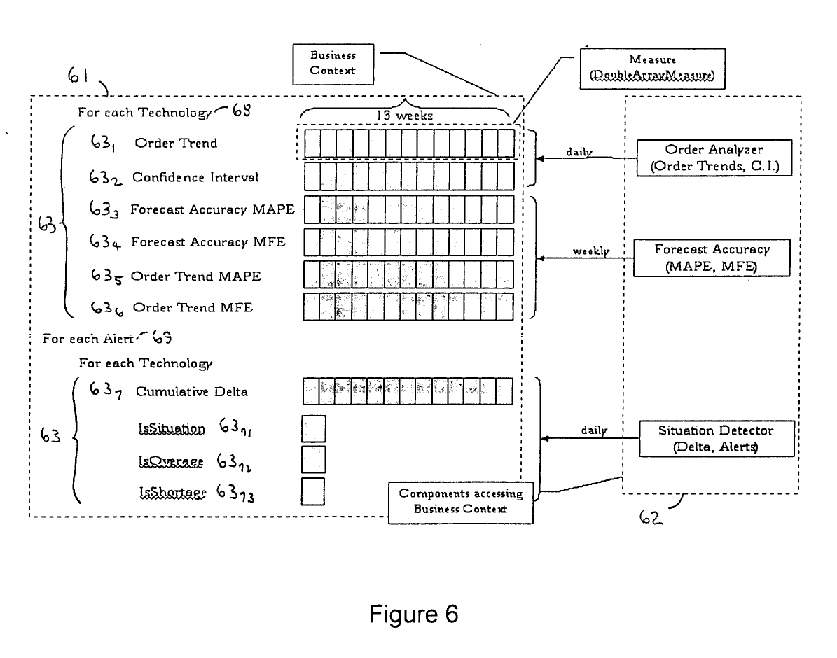

FIG. 6 illustrates an example of the Business Context based on the demand supply conditioning process. The system consists of a business context 61 and external systems 62 which communicate with the business context using the communication and notification services. The business context contains multiple KPIs 63: order trend 63₁, confidence interval 63₂, forecast accuracy MAPE (Mean Absolute Percentage Error) 63₃, Forecast MFE (Mean Forecast Error) 63₄, order trend accuracy MAPE 63₅, Order Trend MFE (Mean Forecast Error) 63₆, and cumulative difference between demands forecast and supply commit 63₇, including indications whether the difference 63₇ is within plan 63₇₁ or reflects an overage 63₇₂ or a shortage 63₇₃. The KPIs are organized in two dimensions—technology 68 and alert 69. Some KPIs are mapped to both dimensions whereas some are mapped to only the technology dimension. This configuration can be done by the configuration model 50. Each of the KPIs are multi-values and are thus represented by a user defined data type (MultiDimArray). This is a user specific extension plugged into the system by extending the Measure Object 42 in the object model. External systems/components 62 update appropriate KPIs of the business context 61. Each of these components could either subscribe to or listen for changes in the values of KPIs or access the KPI values directly in order to perform further analysis.

Based on the above model, here are some of the questions which external components 62 can ask by querying the context 61 using the communication services
What is my Order Trend 63₁ across the next 13 weeks for a technology X.

What is my Cumulative Difference 63₇ between the supply and demand quantities associated with an alert X and technology Y.

In addition the external components 62 might also subscribe for changes and be notified of changes in the above KPIs using the Notification Services 25. The values of the KPIs across the respective dimension could also be displayed on a portal 35 using the Visualization Services 29.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method of hosting on-demand business context information, comprising the steps of:
providing a core set of models for generic key performance indicators used by system components, said models being context object models and configuration models, said context object models providing base representations of said generic key performance indicators, their data types and dimensions, and also allowing extensions of said base representations for specific domains;
using said configuration models to customize said context object models for a domain, said domain being occupied by a set of systems and components having key performance indicators (KPIs), thereby creating a business context hosting layer for access to said KPIs of said domain; and
providing a set of services for said business context hosting layer, said services allowing for querying said KPIs across multiple dimensions and updating said KPIs based on transactional events, said key performance indicators being provided with persistent storage,
wherein said key performance indicators in said customized business context hosting layer are updated and queried in real time.

2. A method of hosting on-demand business context information as in claim 1, wherein said set of services includes
communication services for communication between external systems and components and said customized business context;
notification services for monitoring said KPIs and alerting via said communication services a component using one of said KPIs when said one of said KPIs is out of tolerance;
query services allowing said external systems and components to retrieve the values of a KPI across the dimensions of said KPI;
indexing services for indexing said KPI information to enhance said retrieval;
registry services for registering new KPIs and user defined data types on demand; and
visualization services for viewing said hosted information on a portal.

3. A method of hosting on-demand business context information as in claim 1, further comprising the step of registering new KPIs and user defined data types on demand.

4. A method of hosting on-demand business context information as in claim 1, further comprising the step of providing a view of said KPIs on a portal.

5. A method of hosting on-demand business context information as in claim 1, further comprising the step of monitoring the KPIs and sending an alert to a component using a KPI when said KPI is out of tolerance.

6. A method of hosting on-demand business context information as in claim 1, wherein at least one of said KPIs in said customized business context hosting layer is multi-dimensional and is accessed and updated by a plurality of components in near real time.

7. A method of hosting on-demand business context information as in claim 1, wherein said on-demand business context information is accessible via multiple channels, said multiple channels including web services and stateless session bean.

8. An apparatus for hosting on-demand business context information, comprising:
means for providing a core set of models for generic key performance indicators used by system components, said models being context object models and configuration models, said context object models providing base representations of said generic key performance indicators, their data types and dimensions, and also allowing extensions of said base representations for specific domains;
means for using said configuration models to customize said context object models for a domain, said domain being occupied by a set of systems and components having key performance indicators (KPIs), thereby creating a business context hosting layer for access to said KPIs of said domain; and
means for providing a set of services for said business context hosting layer, said services allowing for querying said KPIs across multiple dimensions and updating said KPIs based on transactional events, said key performance indicators being provided with persistent storage,
wherein said key performance indicators in said customized business context hosting layer are updated and queried in real time.

9. An apparatus for hosting on-demand business context information as in claim 8, wherein said set of services includes
communication services for communication between external systems and components and said customized business context;
notification services for monitoring said KPIs and alerting via said communication services a component using one of said KPIs when said one of said KPIs is out of tolerance;
query services allowing said external systems and components to retrieve the values of a KPI across the dimensions of said KPI;
indexing services for indexing said KPI information to enhance said retrieval;
registry services for registering new KPIs and user defined data types on demand; and
visualization services for viewing said hosted information on a portal.

10. An apparatus for hosting on-demand business context information as in claim 8, further comprising means for registering new KPIs and user defined data types on demand.

11. An apparatus for hosting on-demand business context information as in claim 8, further comprising means for providing a view of said KPIs on a portal.

12. An apparatus for hosting on-demand business context information as in claim 8, further comprising means for monitoring the KPIs and sending an alert to a component using a KPI when said KPI is out of tolerance.

13. An apparatus for hosting on-demand business context information as in claim 8, wherein at least one of said KPIs in said customized business context hosting layer is multi-dimensional and is accessed and updated by a plurality of components in near real time.

14. An apparatus for hosting on-demand business context information as in claim 8, wherein said on-demand business context information is accessible via multiple channels, said multiple channels including web services and stateless session bean.

15. A computer system for hosting on-demand business context information, comprising:
computer code for providing a core set of models for generic key performance indicators used by system components, said models being context object models and configuration models, said context object models providing base representations of said generic key performance indicators, their data types and dimensions, and also allowing extensions of said base representations for specific domains;
computer code for using said configuration models to customize said context object models for a domain, said domain being occupied by a set of systems and components having key performance indicators (KPIs), thereby creating a business context hosting layer for access to said KPIs of said domain; and
computer code for providing a set of services for said business context hosting layer, said services allowing for querying said KPIs across multiple dimensions and updating said KPIs based on transactional events, said key performance indicators being provided with persistent storage,
wherein said key performance indicators in said customized business context hosting layer are updated and queried in real time.
